(19) United States
(12) Patent Application Publication
(10) Pub. No.: US 2022/0127106 A1
(43) Pub. Date: Apr. 28, 2022

(54) FLEXIBLE DISPLAY DEVICE AND TORSION SPRING USED THEREIN

(71) Applicant: BOE TECHNOLOGY GROUP CO., LTD., Beijing (CN)

(72) Inventors: Yanyan YANG, Beijing (CN); Shangchieh CHU, Beijing (CN); Zongyuan WANG, Beijing (CN); Xiaofei LUO, Beijing (CN); Bei WANG, Beijing (CN)

(21) Appl. No.: 17/329,411

(22) Filed: May 25, 2021

(30) Foreign Application Priority Data
Oct. 28, 2020 (CN) 202022434444.X

(51) Int. Cl. B65H 75/48; F16F 1/10; F16F 1/04

(52) U.S. Cl. CPC B65H 75/486; F16F 1/10; F16F 1/043; F16F 2236/08; F16F 2228/066; F16F 2230/0005; F16F 2238/024

(57) ABSTRACT

A torsion spring used in a flexible display device includes a spring body having a first connection end configured to connect a reel of the flexible display device, and a second connection end configured to fix the torsion spring. An axial sectional area of the spring body near the first connection end is greater than an axial sectional area of the spring body away from the first connection end. When the reel rotates, the torsion force generated during the initial rotation of the reel is relatively large, and with the increase of the rotation turn number of the reel, the increase of the torsion force is relatively small.

### CROSS-REFERENCE TO RELATED APPLICATION

This application is based upon, and claims the benefit of and priority to, Chinese Patent Application No. 202022434444.X, filed Oct. 28, 2020, the entire contents of which are incorporated herein by reference.

### TECHNICAL FIELD

The present application relates to the field of display technology and, particularly, relates to a torsion spring and a flexible display device.

### BACKGROUND

In a rollable flexible display device, a torsion spring is installed at both ends of a winding reel respectively, which provides the winding force for the flexible display panel.

Through testing, the flexible display panel requires the same pulling force in the unfolded state and wound state. However, the torsion force of the torsion spring is related to the turn number of rotatory deformation, and the torsion force of the torsion spring is the smallest when the flexible display panel is in the wound state. With the unfolding of the flexible display panel and the increase of the winding turn number of the torsion spring, the curling deformation of the torsion spring increases accordingly, and the torsion force also increases accordingly. This will result in the excessive torsion force of the torsion spring when the flexible display panel is in the fully unfolded state, which makes both the pulling force applied on the flexible display panel and the pulling force which a pulling device needs to provide larger. Moreover, the current installation method of the torsion spring makes the whole volume of the flexible display device lager.

The above information disclosed in the background technology section is only used to enhance the understanding of the background of the present disclosure, therefore it may include information that does not constitute the prior art known to those of ordinary skill in the art.

### SUMMARY

The object of the present application is to provide a torsion spring having a small torsion force when the flexible display panel is in the fully unfolded state, and a flexible display device including the torsion spring.

The additional aspects and advantages of the present application will be partly described in the following description, and will partly become apparent from the description, or can be learned through the practice of the present application.

According to one aspect of the present disclosure, a torsion spring is provided, including:

a spring body having a first connection end configured to connect a reel, and a second connection end configured to fix the torsion spring; and where an axial sectional area of the spring body near the first connection end is greater than an axial sectional area of the spring body away from the first connection end.

According to one aspect of the present disclosure, a flexible display device is provided, including the torsion spring according to any one of the above.

### BRIEF DESCRIPTION OF THE DRAWINGS

The above and other features and advantages of the present application will become more apparent by detailed description of the exemplary embodiments with reference to the accompanying drawings.

FIG. 1 is a schematic structural diagram of a torsion spring in related art;

FIG. 2 is a schematic structural diagram of a torsion spring of FIG. 1 before being formed;

FIG. 3 is a schematic structural diagram of the torsion spring of FIG. 1 installed to a torsion spring installation shell;

FIG. 4 is a schematic perspective diagram of a flexible display device in related art;

FIG. 5 is a schematic exploded perspective diagram of FIG. 4;

FIG. 6 is a schematic structural diagram of an exemplary embodiment of a torsion spring according to the present application;

FIG. 7 is a schematic structural diagram of the torsion spring of FIG. 6 before being formed;

FIG. 8 is a schematic structural diagram of another exemplary embodiment of a torsion spring according to the present application;

FIG. 9 is a schematic structural diagram of the torsion spring of FIG. 9 before being formed;

FIG. 10 is a schematic structural diagram of an exemplary embodiment of a flexible display device according to the present application; and

FIG. 11 is an exploded schematic perspective diagram of FIG. 10.

### DETAILED DESCRIPTION

Exemplary embodiments will now be described more fully with reference to the accompanying drawings. However, the exemplary embodiments may be implemented in various forms, and should not be understood as being limited to the embodiments described herein; rather, these embodiments are provided so that the present application will be comprehensive and complete, and the concept of the exemplary embodiments will be fully conveyed to those skilled in the art. The same reference numerals in the figures denote the same or similar structures, and thus detailed descriptions thereof will be omitted.

The reference numerals of the components in the drawings are explained as below: 100, winding portion; 101, housing; 102, reel; 103, torsion spring assembly; 103-1, torsion spring installation shell; 103-2, torsion spring; 103-21, first connection end; 103-22, spring body; 103-23, second connection end; 104, torsion spring fixing member; 105, fixing shaft; and 200, fixing portion; 300, flexible display panel; 400, bracket.

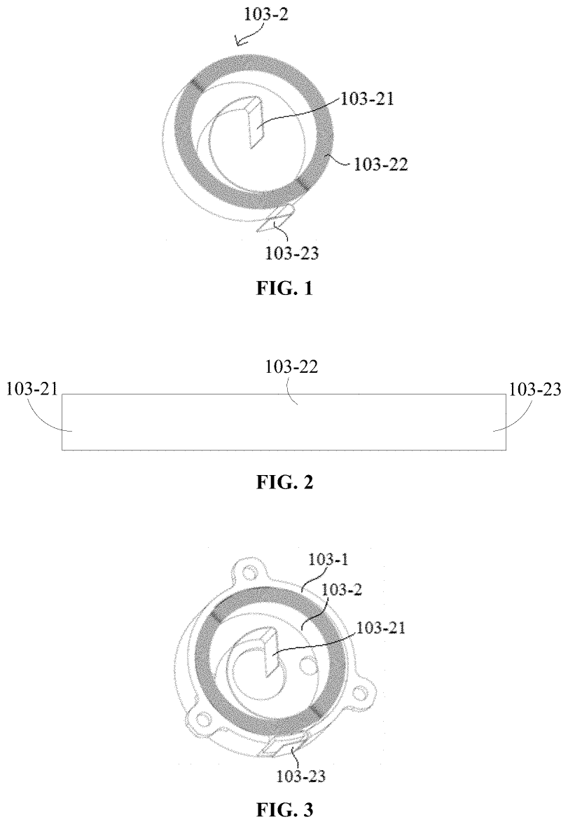

Referring to the schematic structural diagram of the torsion spring 103-2 in the related art shown in FIG. 1 and FIG. 2, the torsion spring 103-2 is formed by a torsion spring elastic sheet with same width and thickness formed into a spiral shape. The spiral line of the torsion spring 103-2 is in one plane. In the case that all the parts of the spring body 103-22 twist at the same angle, the torsion force generated is the same. With the unfolding of the flexible display panel 300 and the increase of the winding turn number of the torsion spring 103-2, the curling deformation of the torsion spring 103-2 increases accordingly and the torsion force also increases accordingly, which makes the torsion force of the torsion spring 103-2 excessively large when the flexible display panel 300 is in a fully unfolded state.

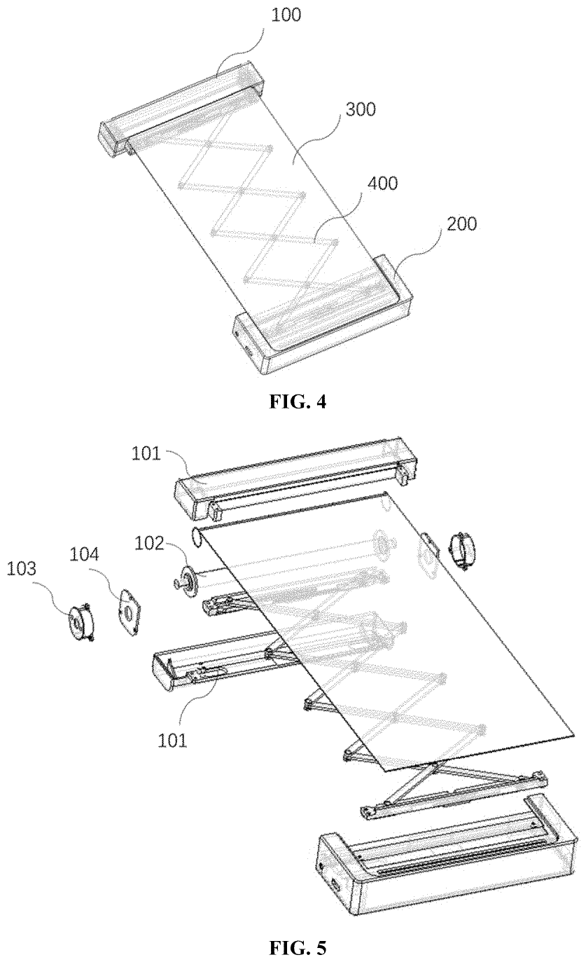

Referring to the schematic structural diagram of the torsion spring 103-2 installed to the torsion spring installation shell 103-1 shown in FIG. 3, the torsion spring 103-2 is installed in the torsion spring installation shell 103-1 to form the torsion spring assembly 103, and the second connection end 103-23 located at the outermost ring of the torsion spring 103-2 is fixedly connected with the torsion spring installation shell 103-1. Referring to the schematic structural diagram of the flexible display device in related art shown in FIG. 4 and FIG. 5, the flexible display device includes a flexible display panel 300, a winding portion 100, and a fixing portion 200, and the flexible display panel 300 is connected between the winding portion 100 and the fixing portion 200. A main board, a battery, and the like are arranged in the fixing portion 200. A bracket 400 is also connected between the winding portion 100 and the fixing portion 200. The bracket 400 is configured to support the unfolded flexible display panel 300, and also configured to connect the winding portion 100 and the fixing portion 200 so as to ensure that the flexible display device does not skew when pulled to open. The winding portion 100 may include a housing 101 in which a reel 102 is arranged, one end of the flexible display panel 300 is fixed to the reel 102, so that the flexible display panel 300 is able to be wound on the reel. The torsion spring assembly 103 formed by the torsion spring 103-2 and the torsion spring installation shell 103-1 as shown in FIG. 3 are respectively fixed on the outer ring surfaces of both ends of the reel 102, and the torsion spring installation shell 103-1 is fixedly connected with the housing 101 by a torsion spring fixing member 104, and the torsion spring 103-2 is configured to provide a pulling force for the flexible display panel 300, so that the flexible display panel 300 may be flattened and wound under the action of the pulling force. The first connection end 103-21 located at the innermost ring of the torsion spring 103-2 is fixedly connected with the reel 102. During the unfolding and winding of the flexible display panel 300, the reel 102 drives the torsion spring 103-2 to rotate and deform, and when the flexible display panel 300 is fully unfolded, the torsion spring 103-2 has the greatest rotatory deformation, and the torsion spring 103-2 has the maximum torsion force at this time. Moreover, the installation method of fixing the torsion spring 103-2 on the outer ring surfaces of both ends of the reel 102 makes the whole volume of the flexible display device relatively large.

The exemplary embodiment provides a torsion spring 103-2 first, referring to the schematic structural diagram of the torsion spring 103-2 according to the exemplary embodiments of the present application shown in FIG. 6-9. The torsion spring 103-2 may include a spring body 103-22 having a first connection end 103-21 configured to connect the reel 102, and a second connection end 103-23 configured to fix the torsion spring 103-2; and where the axial sectional area of the spring body 103-22 near the first connection end 103-21 is greater than the axial sectional area of the spring body 103-22 away from the first connection end 103-21.

In the case that all parts of the torsion spring 103-2 and the spring body 103-22 of the exemplary embodiment twist at the same angle, the torsion force generated by the spring body 103-22 near the first connection end 103-21 is greater than the torsion force generated by the spring body 103-22 away from the first connection end 103-21; and the first connection end 103-21 is configured to connect the reel 102, so that when the reel 102 rotates, the torsion force generated during the initial rotation of the reel 102 is larger, and with the increase of the rotation turn number of the reel 102, the increase of the torsion force is small, thereby improving the situation that the torsion force is excessively large when the torsion spring 103-2 is in the maximum torsion state.

In the exemplary embodiment of the present application, the axial section is the section formed by cutting the spring body 103-22 along the axial direction of the torsion spring 103-2, and the axial sectional area is the sectional area of a coil of the spring body 103-22 formed by cutting the spring body 103-22 along the axial direction of the torsion spring 103-2. The width of the spring body 103-22 refers to the dimension along the axial direction of the torsion spring 103-2 in the unfolded state (before being formed), and the thickness of the spring body 103-22 refers to the dimension perpendicular to the axial direction of the torsion spring 103-2 in the unfolded state (before being formed), and the length of the spring body 103-22 refers to the length in the unfolded state (before being formed).

In the exemplary embodiment of the present application, the spring body 103-22 may be provided as a sheet shape, for example, the axial section of the spring body 103-22 may be a rectangle, and the axial sectional area of the spring body 103-22 is the product of the thickness and width of the rectangle.

In the case that the thickness of the spring body 103-22 is the same everywhere, the width of the spring body 103-22 near the first connection end 103-21 may be greater than the width of the spring body 103-22 away from the first connection end 103-21, so that the axial sectional area of the spring body 103-22 near the first connection end 103-21 is greater than the axial sectional area of the spring body 103-22 away from the first connection end 103-21, so that the inner ring width of torsion spring 103-2 is wider and the outer ring width of torsion spring 103-2 is narrower. Specifically, as shown in FIG. 6 and FIG. 7, the width of the spring body 103-22 may increase linearly, so that the shape of the plane formed by the length and width of the spring body 103-22 when unfolded (before being formed) may be a right-angled trapezoid. Also, in other exemplary embodiments of the present application, the shape of the plane formed by the length and width of the spring body 103-22 when unfolded (before being formed) may also be an isosceles trapezoid or an isosceles triangle, or may be a right-angled triangle, and the like.

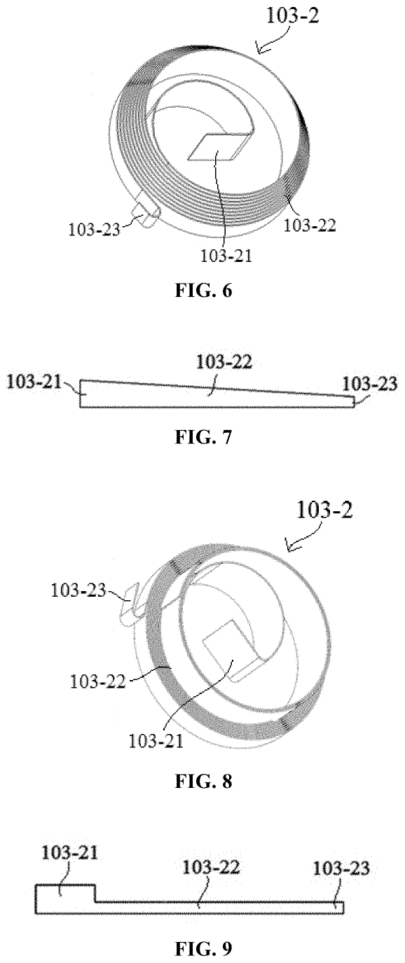

As shown in FIG. 8 and FIG. 9, the width direction of the spring body 103-22 may also be provided as a step shape, that is, the width of the spring body 103-22 does not increase linearly, but changes abruptly. Moreover, one or more steps may be set as required.

In addition, in some other exemplary embodiments of the present application, the width of the spring body 103-22 may be provided as the same, while the thickness of the spring body 103-22 may be altered. That is, in the case that the width of the spring body 103-22 is the same everywhere, the thickness of the spring body 103-22 near the first connection end 103-21 may be greater than the thickness of the spring body 103-22 away from the first connection end 103-21, and likewise, the axial sectional area of the spring body 103-22 near the first connection end 103-21 may be greater than the axial sectional area of the spring body 103-22 away from the first connection end 103-21, so that the inner ring thickness of torsion spring 103-2 is thicker, and the outer ring thickness is thinner. Specifically, the thickness of the spring body 103-22 may increase linearly, so that the shape of the plane formed by the length and width of the spring body 103-22 when unfolded (before being formed) may be a right-angled trapezoid. Also, in other exemplary embodiments of the present application, the shape of the plane formed by the length and width of the spring body 103-22 when unfolded (before being formed) may also be an isosceles trapezoid or an isosceles triangle, or may be a right-angled triangle, and the like.

The thickness direction of the spring body 103-22 may also be provided as a step shape, so that the shape of the spring body 103-22 when unfolded may be a step shape, that is, the thickness of the spring body 103-22 does not increase linearly, but changes abruptly. Moreover, one or more steps may be set as required.

Also, both the width and the thickness of the spring body 103-22 may also decrease with the increase of the distance from the first connection end 103-21, that is, the width of the spring body 103-22 near the first connection end 103-21 is greater than the width of the spring body 103-22 away from the first connection end 103-21, and the thickness of the spring body 103-22 near the first connection end 103-21 is greater than the thickness of the spring body 103-22 away from the first connection end 103-21.

Moreover, in still other exemplary embodiments of the present application, the axial section of the spring body 103-22 may be an ellipse. In this case, the long axis of the ellipse may remain unchanged, while the short axis of the ellipse decreases with the increase of the distance from the first connection end 103-21. Alternatively, the short axis of the ellipse may remain unchanged, while the long axis of the ellipse decreases with the increase of the distance from the first connection end 103-21. Both the long axis and the short axis of the ellipse may also decrease with the increase of distance from the first connection end103-21.

In some other exemplary embodiments of the present application, the spring body 103-22 may be provided as a cylinder shape, that is, the axial section of the spring body 103-22 is a circle with a radius r, and the axial section area of the spring body 103-22 is πr², which is proportional to the square of the radius r of the circle. In this case, the diameter of the spring body 103-22 near the first connection end 103-21 is greater than the diameter of the spring body 103-22 away from the first connection end 103-21, and likewise, the axial sectional area of the spring body 103-22 near the first connection end 103-21 may be greater than the axial sectional area of the spring body 103-22 away from the first connection end 103-21.

It should be noted that the shape of the axial section of the spring body 103-22 is not limited to the above description. For example, the axial section of the spring body 103-22 may also be a trapezoid, a polygon, and the like, as long as the axial sectional area of the spring body 103-22 near the first connection end 103-21 is greater than the axial sectional area of the spring body 103-22 away from the first connection end 103-21. When the torsion spring 103-2 rotates and deforms, the inner ring of the spring body 103-22 begins to deform first, and the outer ring of the spring body 103-22 also deforms with the increase of the rotation turn number. However, the axial sectional area of the outer ring of the spring body 103-22 is small, and the torsion force generated by the deformation is relatively small, which is conductive to reducing the torsion force of the torsion spring 103-2 when the turn number of rotatory deformation is relatively large.

In addition, it should be noted that in the above exemplary embodiments, the first connection end 103-21 is located at the innermost ring of the torsion spring 103-2, and the second connection end 103-23 is located at the outermost ring of the torsion spring 103-2. In some other exemplary embodiments of the present application, the first connection end 103-21 may also be located at the outermost ring of the torsion spring 103-2, and the second connection end 103-23 may be located at the innermost ring of the torsion spring 103-2.

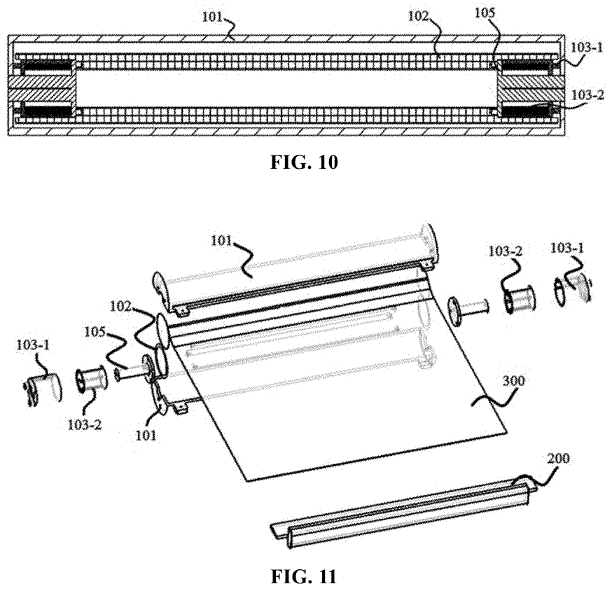

Furthermore, the exemplary embodiment also provides a flexible display device. Referring to the schematic structural diagram of the flexible display device shown in FIG. 10 and FIG. 11, the flexible display device may include the torsion spring 103-2 according to any one of the above. The specific structure of torsion spring 103-2 has been described in detail above, so it will not be repeated here.

In the exemplary embodiment, the flexible display device may also include a housing 101, in which a reel 102 is arranged. Through holes are coaxially arranged on the reel 102, so that the reel 102 is provided as a hollow shape, and the diameter of the first through hole located at both ends of the reel 102 is greater than the diameter of the second through hole located in the middle. The first through holes enable installation cavities to be formed on both ends of the reel 102, and the inner cavity of the reel 102 is formed as a step shape, which may not only ensure the strength of the reel 102, but also allow enough space to install the torsion spring 103-2.

A fixing shaft 105 including a connection plate and a shaft portion is fixed in the installation cavity. The connection plate and the shaft portion are coaxially arranged and fixedly connected, and the diameter of the connection plate is greater than the diameter of the shaft portion. The fixing shaft 105 is coaxially arranged with the reel 102, and the connection plate of the fixing shaft 105 may be fixedly connected to the step surface of the inner cavity of the reel 102 by screws, and the other end of the shaft portion of the fixing shaft 105 may be rotatably connected to the housing 101. Specifically, a through hole may be arranged on the housing 101, and the fixing shaft 105 may rotate after the other end thereof is inserted into the through hole; and a bearing may also be installed in the through hole, and the other end of the fixing shaft 105 may be inserted into the inner ring of the bearing, so that the fixing shaft 105 may rotate.

The diameter of the shaft portion of the fixing shaft 105 is smaller than the diameter of the second through hole, so that an installation space is formed between the fixing shaft 105 and the reel 102. A torsion spring installation shell 103-1 is provided in the installation space and provided as a tubular shape, and one end of the torsion spring installation shell 103-1 is fixedly connected with the housing 101, and the torsion spring 103-2 is installed between the torsion spring installation shell 103-1 and the fixing shaft 105. Specifically, the first connection end 103-21 of the torsion spring 103-2 is fixed to the fixing shaft 105, and the second connection end 103-23 of the torsion spring 103-2 is fixed to the inner side wall of the torsion spring installation shell 103-1.

In other exemplary embodiments of the present application, the reel 102 may be directly provided with a structure with a thicker middle part and two thinner ends, and the two thinner ends are configured to install the torsion spring 103-2.

The torsion spring 103-2 is installed in the reel 102, thereby effectively reducing the whole volume, while ensuring that the torsion spring 103-2 provides the winding force for the flexible display panel 300 in the whole device.

During assembling, one end of the flexible display panel 300 is fixed on the reel 102 first, and then when the flexible display panel 300 is in the fully unfolded state, the torsion spring 103-2 is pre-tightened several turns towards the winding direction of the flexible display panel 300 to provide the torsion force for the flexible display panel 300, so as to ensure that the flexible display panel 300 is able to be wound on the reel naturally, and able to be flattened when unfolded.

The features, structures or characteristics described above may be combined in one or more embodiments in any suitable manner, and if possible, the features discussed in each embodiment are interchangeable. In the above description, many specific details are provided so that a full understanding of the embodiments of the present application is provided. However, those skilled in the art will realize that the technical solutions of the present application may be practiced without one or more of the specific details, or other methods, components, materials, etc. may be adopted. In other cases, well-known structures, materials or operations are not shown or described in detail to avoid obscuring various aspects of the present application.

Although relative terms are used in this specification, such as “upper” and “lower” to describe the relative relationship of one component of a reference numeral to another component, these terms used herein are only for convenience, such as according to a direction of an example depicted in the accompanying drawing. It can be understood that if a device of a reference numeral is turned over and so as to be upside down, the component described as “upper” will become the “lower” component. Other relative terms, such as “high”, “low”, “top”, and “bottom” have similar meanings. When a certain structure is “on” other structure, it means that the certain structure may be integrally formed on the other structure, or the certain structure may be “directly” arranged on the other structure, or the certain structure may be “indirectly” arranged on the other structure by another structure.

In this specification, the terms “a/an”, “one”, “the” and “said” are used to indicate that there are one or more elements/components/etc.; and the terms “comprise”, “include” and “have” are used to indicate the meaning of open inclusion, and means that there may be other elements/components/etc. in addition to the listed elements/components/etc.; and the terms “first”, “second”, “third” and the like are only used as signs, and are not limitation on the number of objects.

It should be understood that the present application does not limit its application to the detailed structure and arrangement of the components proposed herein. The present application may have other embodiments, and may be implemented and executed in various ways. The aforementioned variations and modifications shall fall within the scope of the present application. It should be understood that the present application disclosed and defined herein extends to all alternative combinations of two or more individual features mentioned or apparent in the literature and/or accompanying drawings. All these different combinations constitute a plurality of alternative aspects of the present application. The embodiment described herein illustrates the best well-known method to implement the present application, and will enable those skilled in the art to make use of the present application.

What is claimed is:

1. A flexible display device, comprising:
a reel provided with an installation cavity at an end of the reel and a torsion spring installed in the installation cavity,
wherein the torsion spring comprises a spring body having a first connection end configured to connect a reel, and a second connection end configured to fix the torsion spring; and
wherein an axial sectional area of the spring body near the first connection end is greater than an axial sectional area of the spring body away from the first connection end.

2. The device according to claim 1, further comprising:
a fixing shaft fixed in the installation cavity and coaxially arranged with the reel, wherein the first connection end of the torsion spring is fixed to the fixing shaft; and
a torsion spring installation shell fixed to a housing, wherein the second connection end of the torsion spring is fixed to an inner side wall of the torsion spring installation shell.

3. The device according to claim 2, wherein the axial section of the spring body is formed in shape of rectangular.

4. The device according to claim 3, wherein a width of the spring body near the first connection end is greater than a width of the spring body away from the first connection end, and a thickness of the spring body is same.

5. The device according to claim 4, wherein the width of the spring body increases linearly or increases in stepped manner.

6. The device according to claim 3, wherein a thickness of the spring body near the first connection end is greater than a thickness of the spring body away from the first connection end, and a width of the spring body is same.

7. The device according to claim 6, wherein the thickness of the spring body increases linearly or increases in stepped manner.

8. The device according to claim 3, wherein a width of the spring body near the first connection end is greater than a width of the spring body away from the first connection end, and a thickness of the spring body near the first connection end is greater than a thickness of the spring body away from the first connection end.

9. The device according to claim 2, wherein the axial section of the spring body is formed in shape of circle.

10. The device according to claim 9, wherein a diameter of the spring body near the first connection end is greater than a diameter of the spring body away from the first connection end.

11. A torsion spring used in a flexible display device, comprising:
a spring body having a first connection end configured to connect a reel of the flexible display device, and a second connection end configured to fix the torsion spring;
wherein an axial sectional area of the spring body near the first connection end is greater than an axial sectional area of the spring body away from the first connection end.

12. The torsion spring according to claim 11, wherein the axial section of the spring body is formed in shape of rectangular.

13. The torsion spring according to claim 12, wherein a width of the spring body near the first connection end is greater than a width of the spring body away from the first connection end, and a thickness of the spring body is same.

14. The torsion spring according to claim 13, wherein the width of the spring body increases linearly or increases in stepped manner.

15. The torsion spring according to claim 12, wherein a thickness of the spring body near the first connection end is greater than a thickness of the spring body away from the first connection end, and a width of the spring body is same.

16. The torsion spring according to claim 15, wherein the thickness of the spring body increases linearly or increases in stepped manner.

17. The torsion spring according to claim 12, wherein a width of the spring body near the first connection end is greater than a width of the spring body away from the first connection end, and a thickness of the spring body near the first connection end is greater than a thickness of the spring body away from the first connection end.

18. The torsion spring according to claim 11, wherein the axial section of the spring body is formed in shape of circle.

19. The torsion spring according to claim 18, wherein a diameter of the spring body near the first connection end is greater than a diameter of the spring body away from the first connection end.
